(19) United States
(12) Patent Application Publication
(10) Pub. No.: US 2015/0035681 A1
(43) Pub. Date: Feb. 5, 2015

(54) Point-to-Multipoint Polling in a Monitoring System for an Electric Power Distribution System

(71) Applicant: Schweitzer Engineering Laboratories, Inc., Pullman, WA (US)

(72) Inventors: Richard Paul Bryson, JR., Colfax, WA (US); Eric Sagen, Pullman, WA (US)

(73) Assignee: Schweitzer Engineering Laboratories, Inc., Pullman, WA (US)

(21) Appl. No.: 13/956,926

(22) Filed: Aug. 1, 2013

(51) Int. Cl. G01D 4/00

(52) U.S. Cl. CPC G01D 4/002
USPC 340/870.02

(57) ABSTRACT

An automation controller may wirelessly poll a plurality of remote monitoring devices configured to monitor an electric power distribution system and store monitored system data collected therefrom. The automation controller may be wirelessly coupled to the plurality of remote monitoring devices using a spread-spectrum protocol, such as Bluetooth®. The automation controller may gather the monitored system data using the Distributed Network Protocol (DNP3). DNP3 packets may be communicated as the payload of Bluetooth® packets. The spread-spectrum protocol may limit the number of devices to which the automation controller may be actively connected at one time. Accordingly, the automation controller may couple and uncouple from the remote monitoring devices in a round-robin pattern to collect the monitored system data from all of the remote monitoring devices. The automation controller may provide engineering access and/or collect relay event data using the spread-spectrum protocol and a high-bandwidth protocol.

### TECHNICAL FIELD

This disclosure relates to point-to-multipoint polling of a plurality of monitoring devices by an automation controller. More particularly, this disclosure relates to wireless point-to-multipoint polling.

### BRIEF DESCRIPTION OF THE DRAWINGS

FIG. 1 illustrates a simplified one-line diagram of an electric power delivery system.

FIG. 2A is a schematic diagram of a system for wirelessly retrieving monitored system data from IEDs.

FIG. 2B is a schematic diagram of the system for wirelessly retrieving monitored system data from IEDs during communication.

FIG. 3 is a flow diagram of a method for the controller communication device to communicatively couple to an IED communication device.

FIG. 4 is a flow diagram of a method for the automation controller to gather monitored system data from a plurality of IEDs.

### DETAILED DESCRIPTION OF PREFERRED EMBODIMENTS

An electric power distribution system may have numerous monitoring devices for monitoring and controlling various aspects of the electric power distribution system. The monitoring devices may collect monitored system data from the electric power distribution system. One or more monitoring devices may be Intelligent Electronic Devices (IEDs). An automation controller may aggregate data from a plurality of remote monitoring devices. The automation controller may perform mathematical and/or logical calculations on the aggregated data and/or may concentrate the data. The automation controller may transmit calculation results and/or concentrated data to a central monitoring system, where it can be reviewed by an operator, stored for later analysis, and/or the like. In an embodiment, the automation controller may be located at a substation and may gather data from remote monitoring devices at the substation.

The automation controller may gather data from a large number of remote monitoring devices. Accordingly, if the automation controller is coupled to the remote monitoring devices using wires, a large number of wires and/or long lengths of wire may be required. The wires can be expensive, can clutter equipment boxes, can be subject to failure, and/or the like. To resolve these problems, the automation controller may communicate with the remote monitoring devices wirelessly. A controller transceiver may be coupled to the automation controller, and a monitoring device transceiver may be coupled to each remote monitoring device. For example, the transceivers may be coupled to communication ports, such as serial ports, USB ports, RJ-45 ports, and/or the like. The transceivers may transfer commands, monitored system data, and/or the like between the automation controller and the remote monitoring devices. The transceivers may also, or instead, allow for engineering access and/or relay event collection.

In an embodiment, the transceivers may communicate using a spread-spectrum radio protocol, such as a direct-sequence spread-spectrum protocol, a frequency-hopping spread-spectrum protocol, and/or the like. The spread-spectrum radio protocol may enhance reliability of communications between the transceivers by making the communications less susceptible to interference from noise and/or jamming and providing mild protection against spoofing. The transceivers may share a spreading pattern (e.g., a direct pseudorandom sequence, a frequency hop sequence, etc.) to allow the transceivers to receive each other's transmissions. In an embodiment, the transceivers may use a Bluetooth® protocol to communicate. The Bluetooth® protocol may also allow communications between the transceiver to be encrypted further protecting against spoofing and other attacks.

The automation controller may communicate with each remote monitoring device sequentially in a round-robin pattern to gather the monitored system data. The automation controller may determine the next remote monitoring device from which to gather monitored system data. The automation controller may communicatively couple the controller transceiver to the monitoring device transceiver of the determined remote monitoring device by creating a shared spreading pattern that permits the transceivers to communicate using the spread-spectrum radio protocol. The automation controller may send a poll to the determined remote monitoring device. The poll may request the monitored system data. In reply, the automation controller may receive a response containing the monitored system data from the determined remote monitoring device.

After receiving a complete response to the poll, the automation controller may uncouple the controller transceiver from the monitoring device transceiver of the determined remote monitoring device. Uncoupling may include ending communications between the transceivers, such as by deleting the shared spreading pattern at one or more of the transceivers, and/or instructing the monitoring device transceiver to enter a standby state with minimal communication between the controller transceiver and the monitoring device transceiver, such as the Bluetooth® park mode.

In an embodiment, the automation controller and the determined remote monitoring device may communicate using a supervisory control and data acquisition (SCADA) protocol, such as the Distributed Network Protocol (DNP3). The automation controller may be configured as a DNP3 multi-drop client with the remote monitoring devices configured as DNP3 slaves. The automation controller may send a poll by sending a DNP3 poll and may receive a response comprising a DNP3 poll response. The DNP3 packets may be encapsulated in the spread-spectrum radio protocol packets (e.g., in the Bluetooth® packets).

The DNP3 slaves may assign classes to the gathered data based on the priority of the data. For example, class 0 may be assigned to static data and classes 1, 2, and 3 may be assigned to events, such as changes in data values, with class 1 assigned to the highest priority events and class 3 assigned to the lowest priority events. The automation controller may gather different classes of data during different data gathering iterations. The automation controller may gather a first set of data during a first iteration and a second set of data during a second iteration. Different classes may be included in the first and second sets of data, such as the first set of data including at least one class of data not included in the second set of data. For example, all four classes may be gathered during a first iteration, and only class 1 data may be gathered during a second iteration. In an embodiment, class 1 data may be gathered most frequently and class 0 data may be gathered least frequently.

In an embodiment, the transceivers may be used, for example, by the automation controller to provide a user with engineering access to a remote monitoring device and/or to allow collection of relay event data. The transceivers may communicatively couple the automation controller to the remote monitoring device. The user may then be able to tunnel through to the remote monitoring device for engineering access. The user may directly communicatively couple to the automation controller through a wired or wireless connection. Alternatively, the user may be communicatively coupled to the automation controller through a remote Ethernet connection. The direct and/or remote communicative coupling may be initiated by the user.

Engineering access may include accessing the remote monitoring device using a terminal session, configuring software operating on the remote monitoring device, viewing present data values, and/or the like. When the user desires to connect to one or more remote monitoring devices, the user may begin by connecting to the automation controller. The user may indicate to the automation controller to which remote monitoring device(s) the user wishes to connect. In response, the automation controller may instruct the controller transceiver to communicatively couple to the monitoring device transceiver of the remote monitoring device of interest.

The user is then able to perform the desired actions on the remote monitoring device. In an embodiment, the user may interact with the remote monitoring device using a high-bandwidth protocol (e.g., a non-SCADA protocol, such as a proprietary protocol). The high-bandwidth protocol may be able to transfer more information from the remote monitoring device to the automation controller in a desired time interval than could a SCADA protocol. The automation controller may receive commands from the user, and the automation controller may transmit the commands to the remote monitoring device using the high-bandwidth protocol and transmit responses to the user. The controller transceiver and/or the monitoring device transceiver may encapsulate the high-bandwidth protocol in the spread-spectrum radio protocol packets to deliver them to the remote monitoring device.

Once the user has finished performing the desired actions, the user may indicate that the connection is no longer needed. The automation controller may instruct the controller transceiver to uncouple from the monitoring device transceiver. If the user has indicated another remote monitoring device, the automation controller may instruct the controller transceiver to connect to the monitoring device transceiver of the next remote monitoring device.

Relay event data collection may be performed automatically by the automation controller, manually by a user, and/or the like. Relay event data may include historical graphic waveform data and/or the like from before and/or after a relay event, such as a fault. Relay events and DNP3 events may not necessarily correspond to one another. Additionally, relay event data may be too voluminous to be gathered with the DNP3 protocol. Accordingly, the relay event data may be collected by encapsulating a high-bandwidth protocol, such as a proprietary protocol, in the spread-spectrum radio protocol and requesting the relay event data using the high-bandwidth protocol.

When a user or automatic system decides to query a remote monitoring device to determine if relay event data exists and/or decides to collect relay event data, the automation controller may instruct the controller transceiver to communicatively couple to the monitoring device transceiver of a remote monitoring device of interest. The relay event data, if it exists, may be collected. The automation controller may instruct the controller transceiver to uncouple from the monitoring device transceiver. If there are additional remote monitoring devices to query and/or collect relay event data from, the automation controller may instruct the controller transceiver to communicatively couple to the monitoring device transceiver of the next remote monitoring device. While the transceivers are being used to provide engineering access and/or relay event data collection, the automation controller may be gathering DNP3 data using the transceivers, using a wired connection, using additional transceivers with a separate communication link, and/or the like.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described will be illustrated as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a machine-readable storage medium having stored thereon instructions that may be used to program a computer (or other electronic device) to perform processes described herein. The machine-readable storage medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

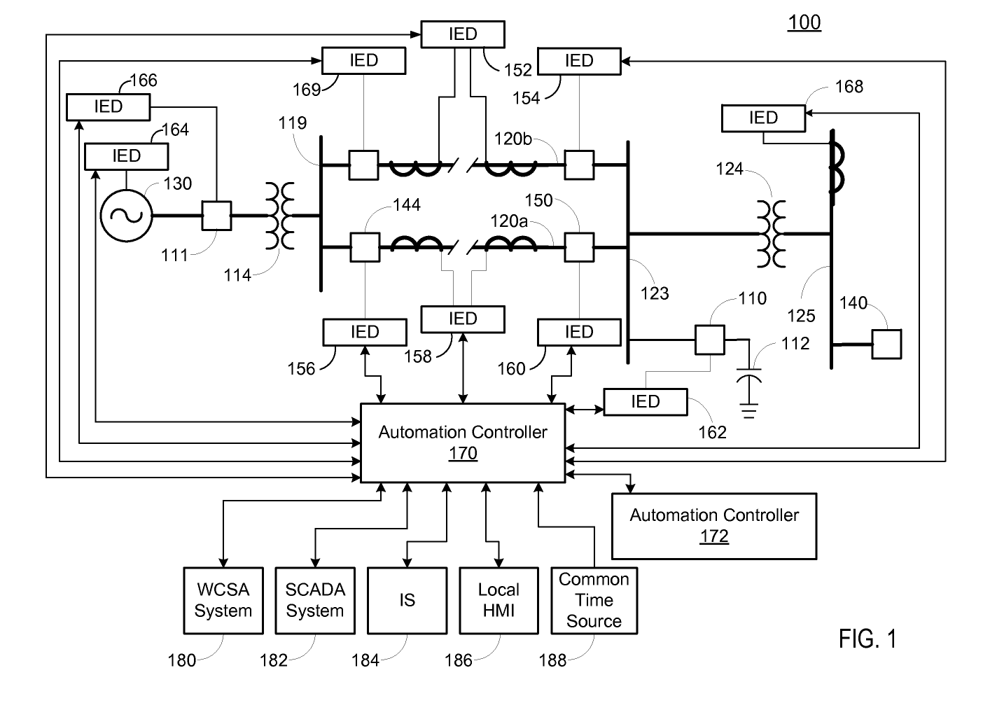

FIG. 1 illustrates a simplified one-line diagram of an electric power delivery system 100. Although illustrated as a one-line diagram, the electric power delivery system 100 may represent a three phase power system. FIG. 1 illustrates a single phase system for simplicity.

The electric power delivery system 100 includes, among other things, a generator 130, configured to generate a sinusoidal waveform. A step-up power transformer 114 may be configured to increase the generated waveform to a higher voltage sinusoidal waveform. A first bus 119 may distribute the higher voltage sinusoidal waveform to transmission lines 120a and 120b, which in turn connect to a second bus 123. Breakers 144, 150, 110, and 111, may be configured to be selectively actuated to reconfigure the electric power delivery system 100. For example, one breaker 110 may selectively connect a capacitor bank 112 to the second bus 123 to maintain a proper balance of reactive power. A step-down power transformer 124 may be configured to transform the higher voltage sinusoidal waveform to lower voltage sinusoidal waveform that is suitable for delivery to a load 140.

IEDs 152-169, shown in FIG. 1, may be configured to control, monitor, protect, and/or automate the electric power system 100. As used herein, an IED may refer to any microprocessor-based device that monitors, controls, automates, and/or protects monitored equipment within an electric power system. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, motor drives, and the like. The IEDs 152-169 may gather status information from one or more pieces of monitored equipment. The IEDs 152-169 may receive information concerning monitored equipment using sensors, transducers, actuators, and the like.

The IEDs 152-169 may also gather and transmit information gathered about monitored equipment. Although FIG. 1 shows separate IEDs monitoring a signal (e.g., 158) and controlling a breaker (e.g., 160) these capabilities may be combined into a single IED. FIG. 1 shows various IEDs performing various functions for illustrative purposes and does not imply any specific arrangements or functions required of any particular IED. IEDs may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. IEDs may also be configured to communicate calculations, such as phasors (which may or may not be synchronized to a common time source as synchrophasors), relay events (e.g., a permanent fault, a temporary fault, an overcurrent condition, an undervoltage condition, a high temperature condition, an inrush condition, a backfeed condition, direction of current flow, loss of potential, a switching transient, a system overload, an exceeded load profile, etc.), relay event data corresponding to a relay event (e.g., graphic waveform data, such as voltages and/or currents, associated with the relay event), fault distances, differentials, impedances, reactances, frequency, and the like. IEDs may also communicate settings information, IED identification information, communications information, status information, alarm information, and the like. Information of the types listed above, or more generally, information about the status of monitored equipment is referred to as monitored system data. Each IED may generate monitored system data regarding properties of the electric power distribution system at points proximate to the IED.

The IEDs 152-169 may also issue control instructions to the monitored equipment in order to control various aspects relating to the monitored equipment. For example, an IED may be in communication with a circuit breaker, and may be capable of sending an instruction to open and/or close the circuit breaker, thus connecting or disconnecting a portion of a power system. In another example, an IED may be in communication with a recloser and capable of controlling reclosing operations. In another example, an IED may be in communication with a voltage regulator and capable of instructing the voltage regulator to tap up and/or down. Other examples of control instructions that may be implemented using IEDs may be known to one having skill in the art, but are not listed here. Information of the types listed above, or more generally, information or instructions directing an IED or other device to perform a certain action is referred to as control instructions.

The IEDs 152-169 may be linked together using a data communications network, and may further be linked to a central monitoring system, such as a SCADA system 182, an information system (IS) 184, or a wide area control and situational awareness (WCSA) system 180. The embodiment of FIG. 1 illustrates a star topology having an automation controller 170 at its center, however, other topologies are also contemplated. For example the IEDs 152-169 may be connected directly to the SCADA system 182 or the WCSA system 180. The data communications network of FIG. 1 may include a variety of network technologies, and may comprise network devices such as modems, routers, firewalls, virtual private network servers, and the like. The IEDs and other network devices may be connected to the communications network through a network communications interface.

The IEDs 152-169 are connected at various points to the electric power delivery system 100. A first IED 152 may be configured to monitor conditions on a first transmission line 120b, while a second IED 158 may monitor conditions on a second transmission line 120a. A plurality of breaker IEDs 154, 156, 160, and 169 may be configured to issue control instructions to associated breakers. A third IED 168 may monitor conditions on a third bus 125. A fourth IED 164 may monitor and issue control instructions to a generator 130, while a fifth IED 166 may issue control instructions to a breaker 111.

In certain embodiments, including the embodiment illustrated in FIG. 1, communication among various IEDs and/or higher level systems (e.g., the SCADA system 182 or the IS 184) may be facilitated by the automation controller 170. The automation controller 170 may also be referred to as a central IED or access controller. In various embodiments, the automation controller 170 may be embodied as the SEL-2020, SEL-2030, SEL-2032, SEL-3332, SEL-3378, or SEL-3530 available from Schweitzer Engineering Laboratories, Inc. of Pullman, Wash., and also as described in U.S. Pat. No. 5,680,324, U.S. Pat. No. 7,630,863, and U.S. Patent Application Publication No. 2009/0254655, the entireties of which are incorporated herein by reference.

Centralizing communications in the electric power delivery system 100 using the automation controller 170 may provide the ability to manage a wide variety of IEDs in a consistent manner. The automation controller 170 may be capable of communicating with IEDs of various types and using various communications protocols. The automation controller 170 may provide a common management interface for managing connected IEDs, thus allowing greater uniformity and ease of administration in dealing with a wide variety of equipment. It should be noted that although an automation controller 170 is used in this example, any device capable of storing time coordinated instruction sets and executing such may be used in place of the automation controller 170. For example, an IED, programmable logic controller, computer, or the like may be used. Any such device is referred to herein as a communication master.

In various embodiments, devices within the electric power delivery system 100 may be configured to operate in a peer-to-peer configuration. In such embodiments, the communication master may be selected from among the available peer devices. Further, the device designated as the communications master may be changed. Such changes may occur as a result of losing communication with a device previously selected as a communications master, as a result of a change in the configuration of electric power delivery system 100, the detection of a specific condition triggering time coordinated action by an IED that is not designated as the communication master at the time of the occurrence of the condition, or under other circumstances.

The IEDs 152-169 may communicate information to the automation controller 170 including, but not limited to status and control information about the individual IEDs, IED settings information, calculations made by individual IEDs, event (fault) reports, communications network information, network security events, and the like. The automation controller 170, may be in communication with a second automation controller 172, in order to increase the number of connections to pieces of monitored equipment or to extend communication to other electric power delivery systems. In alternative embodiments, the automation controller 170 may be directly connected to one or more pieces of monitored equipment (e.g., the generator 130 or the breakers 111, 144, 150, 110).

The automation controller 170 may also include a local human machine interface (HMI) 186. Alternatively, or in addition, the automation controller 170 may be removeably coupleable to a human machine interface, such as a laptop, tablet, cell phone, or the like, through a wireless and/or wired connection, and/or the automation controller 170 may provide a remote human machine interface, such as remote access to an internet-browser-renderable platform over an internet protocol (IP) network. The local HMI 186 may be located at the same substation as the automation controller 170. The local HMI 186 may be used to change settings, issue control instructions, retrieve an event (fault) report, retrieve data, and the like. In this structure, the automation controller 170 may include a programmable logic controller accessible using the HMI 186. A user may use the programmable logic controller to design and name time coordinated instruction sets that may be executed using the HMI 186. The time coordinated instruction sets may be stored in computer-readable storage medium (not shown) on automation controller 170.

The time coordinated instruction set may be developed outside the automation controller 170 (e.g., using WCSA System, or SCADA System) and transferred to the automation controller or through the automation controller to the IEDs 152-169 or, in another embodiment without the automation controller 170, directly to the IEDs 152-169, using a communications network, using a USB drive, or otherwise. For example, time coordinated instruction sets may be designed and transmitted via the WCSA system 180. Further, it is contemplated that the automation controller or IEDs may be provided from the manufacturer with pre-set time coordinated instruction sets. U.S. Pat. No. 7,788,731 titled Method and Apparatus for Customization, naming Robert Morris, Andrew Miller, and Jeffrey Hawbaker as inventors, describes such a method, and is hereby incorporated by reference in its entirety.

The automation controller 170 may also be connected to a common time source 188. In certain embodiments, the automation controller 170 may generate a common time signal based on the common time source 188 that may be distributed to the connected IEDs 152-169. Based on the common time signal, various IEDs may be configured to collect time-aligned data points, including synchrophasors, and to implement control instructions in a time coordinated manner. The WCSA system 180 may receive and process the time-aligned data, and may coordinate time synchronized control actions at the highest level of the power system. In another embodiment, the automation controller 170 may not receive a common time signal, but a common time signal may be distributed to the IEDs 152-169.

The common time source 188 may also be used by the automation controller 170 for time stamping information and data. Time synchronization may be helpful for data organization, real-time decision-making, as well as post-event analysis. Time synchronization may further be applied to network communications. The common time source 188 may be any time source that is an acceptable form of time synchronization, including but not limited to a voltage controlled temperature compensated crystal oscillator, a Rubidium and/or Cesium oscillator with or without a digital phase locked loop, MEMs technology, which transfers the resonant circuits from the electronic to the mechanical domains, or a GPS receiver with time decoding. In the absence of a discrete common time source, the automation controller 170 may serve as the time source by distributing a time synchronization signal (received from one of the sources described).

The automation controller 170 may communicate with the IEDs 152-169 using the Distributed Network Protocol (DNP3). DNP3 was designed to optimize transmission of monitored system data, control instructions, and the like. DNP3 supports several system architectures including a multi-drop architecture. The multi-drop architecture may include a DNP3 master and a plurality of DNP3 slaves. The DNP3 master may send control instructions to the DNP3 slaves and may interrogate the DNP3 slaves to gather monitored system data. The DNP3 master may interrogate a DNP3 slave by transmitting a poll and receiving a response to the poll. In an embodiment, the DNP3 master may interrogate the DNP3 slaves in a round-robin pattern.

The DNP3 master and slaves may transmit and receive data by sending and receiving finitely-sized frames, which may also be referred to as packets. Each frame may include a header, which may include sync byes, an indication of frame length, a control byte for managing the data link layer, a destination address, a source, and error detection/correction, such as a cyclic redundancy check (CRC). Each frame may also include a data section, which may include a pseudo-transport layer byte to manage application layer message fragments comprising multiple frames. The application layer may indicate in each fragment whether additional fragments follow. In an embodiment, the frames may have a maximum size of 292 bytes including a maximum of 250 bytes of data, and the application layer message fragments may have a maximum size corresponding to the anticipated buffer size of the receiving device (e.g., 2,048 bytes to 4,096 bytes in some embodiments).

The monitored system data may include a plurality of data points. Each data point may be assigned an object group based on the format of the data point. Additionally, there may be variations in format within each group, so each data point may have an object group variation assigned as well. A unique index number may be assigned to each data point. The object groups and/or data points may be further assigned classes. Various class configurations are possible. In an embodiment, class 0 may be assigned to static data, and classes 1, 2, and 3 may be assigned to event data, such as changes in the data values. A time may also be stored and associated with each event. Under a configuration, class 1 may be assigned to the highest priority events and class 3 may be assigned to the lowest priority events. Data points may be requested based on object group, variation, index number, and/or class. Different classes may be requested with different frequency. Thus, for events, class 1 may be requested most frequently, and class 3 may be requested least frequently. Class 0 may be requested even less frequently than class 3 and may occur rarely or never.

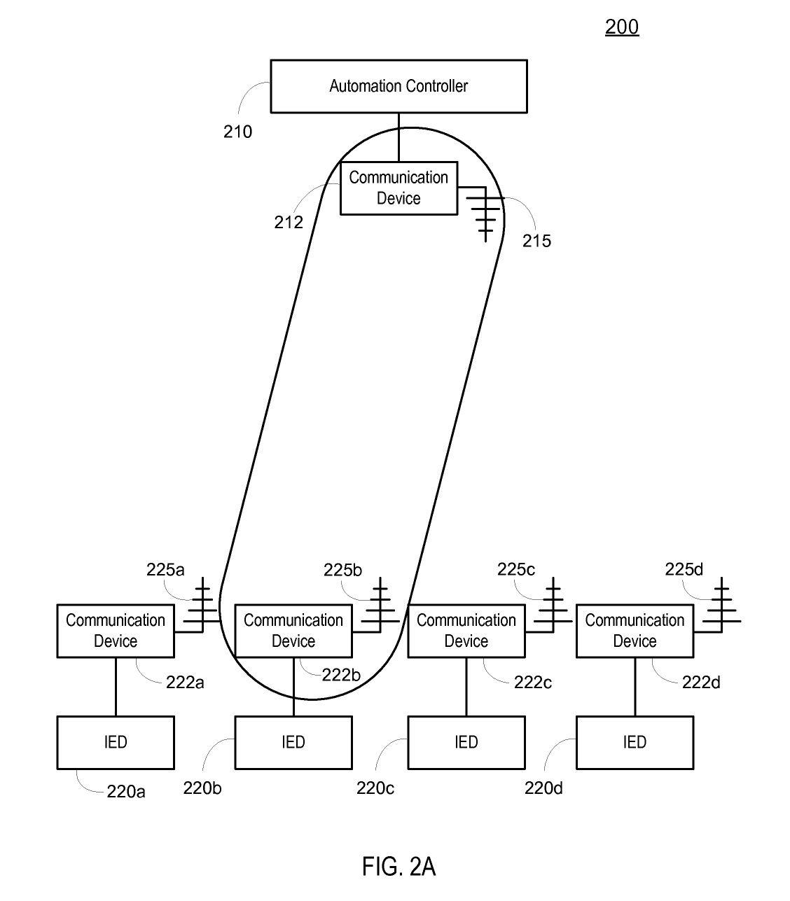

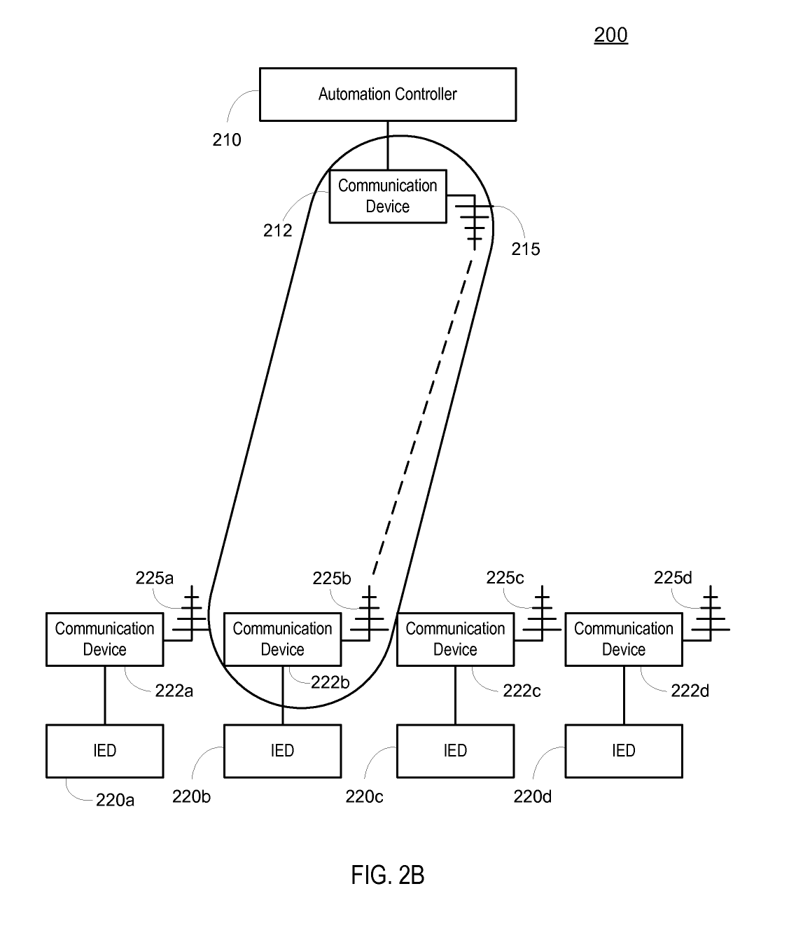

FIG. 2A is a schematic diagram of a system 200 for wirelessly retrieving monitored system data from IEDs 220a-d. An automation controller 210 may include a communication port (not shown), such as a serial port, a USB port, an RJ-45 port, and/or the like. Similarly, each IED 220a-d may also include a communication port (not shown). By wiring the automation controller 210 to the IEDs 220a-d using the communication ports, the automation controller 210 may be able to gather the monitored system data from the IEDs 220a-d. For example, the communication ports may be serial ports compliant with the Telecommunications Industries Association 232 (TIA-232) standard, and the DNP3 protocol may be used for communicating the monitored system data.

Alternatively, or in addition, the automation controller 210 may communicate with the IEDs 220a-d wirelessly through radio frequency (RF) transmissions to reduce the number of wires and/or the number of ports on the automation controller 210. Communication devices 212, 222a-d may be electrically coupled to the automation controller 210 communication port and the communication ports of the IEDs 220a-d respectively. The communication devices 212, 222a-d may be coupled to antennas 215, 225a-d for transmitting and receiving wireless communications. A controller transceiver may be comprised of a controller communication device 212 and/or a controller antenna 215, and a monitoring device transceiver may be comprised of an IED communication device 222a-d and/or an IED antenna 225a-d.

The communication devices 212, 222a-d may be transparent to the automation controller 210 and the IEDs 220a-d. Thus, for example, the communications ports of the automation controller 210 and the IEDs 220a-d may communicate with the communication devices 212, 222a-d according to the TIA-232 standard and the DNP3 protocol as though the automation controller 210 and the IEDs 220a-d were directly connected by a wire. Alternatively, or in addition, the automation controller 210 and/or the IEDs 220a-d may communicate control data and/or the like with the communication devices 212, 222a-d.

The communication devices 212, 222a-d may communicate using a spread-spectrum protocol. The spread-spectrum protocol may protect against spoofing and/or jamming, which could cause damage to the electric power distribution system. In an embodiment, the communication devices 212, 222a-d may use a direct-sequence spread-spectrum protocol. The direct-sequence spread-spectrum protocol may transmit a direct pseudorandom sequence (e.g., a chip) and its inverse at a high chip rate that results in a wide bandwidth. The gain of received signals can be improved by correlating with the direct pseudorandom sequence. As a result, the signal is less susceptible to interference. In addition, the required power for transmitting the signal is lower and can even be below the noise floor. If the signal is below the noise floor, it may be difficult to detect and thus difficult to jam and/or spoof.

In an embodiment, the communication devices 212, 222a-d may use a frequency-hopping spread-spectrum protocol. The frequency-hopping spread-spectrum protocol may transmit on a plurality of frequencies selected according to a pseudorandom frequency hop sequence. The frequency-hopping spread-spectrum protocol may be less susceptible to interference and/or jamming because it changes transmission frequency and/or may be able to adaptively select frequencies to avoid noisy frequencies. The frequency-hopping spread-spectrum protocol may also be difficult to spoof and/or jam because an attacker may not know what frequency will be hopped to next.

For the direct-sequence spread-spectrum protocol and the frequency-hopping spread-spectrum protocol, the spreading pattern (e.g., the direct pseudorandom sequence or the pseudorandom frequency hop sequence) may need to be known by any communication devices 212, 222a-d that are going to be communicating. When two or more communication devices 212, 222a-d have shared a spreading pattern, those communication devices 212, 222a-d are able to communicate and thus may be considered to be communicatively coupled. Communications between the communication devices 212, 222a-d may be encrypted while sharing the spreading pattern to prevent an eavesdropper from being able to use knowledge of the spreading pattern to jam and/or spoof communications. Alternatively, or in addition, communications carrying commands and/or monitored system data may be encrypted.

In an embodiment, the spread-spectrum protocol may be a Bluetooth® protocol. In various embodiments, the communication devices 212, 222a-d may be embodied as Bluetooth® transceivers, such as the SEL-2924 or SEL-2925 available from Schweitzer Engineering Laboratories, Inc. of Pullman, Wash. The controller communication device 212 may be bonded with each of the IED communication devices 222a-d. User input may be used to ensure the correct communication devices 212, 222a-d are being bonded to each other. The communication devices 212, 222a-d may create a shared secret, such as a link key in embodiments using a Bluetooth® protocol. The shared secret may be used by the communication devices 212, 222a-d to authenticate each other in the future.

The controller communication device 212 may communicatively couple with an IED communication device 222b. When a spread-spectrum protocol is being used, communicatively coupling may include sharing a spreading pattern to enable the controller and IED communication devices 212, 222b to communicate using the spread-spectrum protocol. For example, the controller and IED communication devices 212, 222b may use inquiry and/or page messages to establish a piconet 230 in an embodiment using a Bluetooth® protocol. In some embodiments, the communication devices 212, 222b may exchange the spreading pattern over an encrypted channel. Alternatively, or in addition, the monitored system data may be transmitted over an encrypted channel.

FIG. 2B is a schematic diagram of the system 200 for wirelessly retrieving monitored system data from IEDs 220a-d during communication. Once the controller communication device 212 is communicatively coupled with the IED communication device 222b, the automation controller 210 and/or the IED 220b may communicate monitored system data, commands, and/or the like, and/or the automation controller 210 may be given engineering access to the IED 220b. In an embodiment, the automation controller 210 and the IED 220b may communicate using DNP3. The automation controller 210 and/or the IED 220b may transmit one or more DNP3 packets to their respective communication devices 212, 222b using their respective communication ports. The communication devices 212, 222b may remove any overhead included for communication via the communication ports (e.g., remove the framing). Alternatively, the overhead may be included in transmissions between the communication devices 212, 222b.

The one or more DNP3 packet and/or communication port overhead may be encapsulated in a spread-spectrum protocol packet so that the one or more DNP3 packets can be transferred between the communication devices 212, 222b. For example, the entirety of the one or more DNP3 packets including their header and error correction may be encapsulated as the payload of a Bluetooth® packet. The spread-spectrum protocol packet may include additional overhead, such as an access code, a header, error correction, encryption, and/or the like. One DNP3 packet may be included per spread-spectrum protocol packet, and/or more or less than one DNP3 packet may be included per spread-spectrum protocol packet. The communication device 212, 222b receiving the spread-spectrum protocol packet may remove any overhead included in accordance with the spread-spectrum protocol. The one or more received DNP3 packets may be communicated between the receiving communication device 212, 222b and the respective automation controller 210 and/or IED 220b. The receiving communication device 212, 222b may add communication port overhead if necessary.

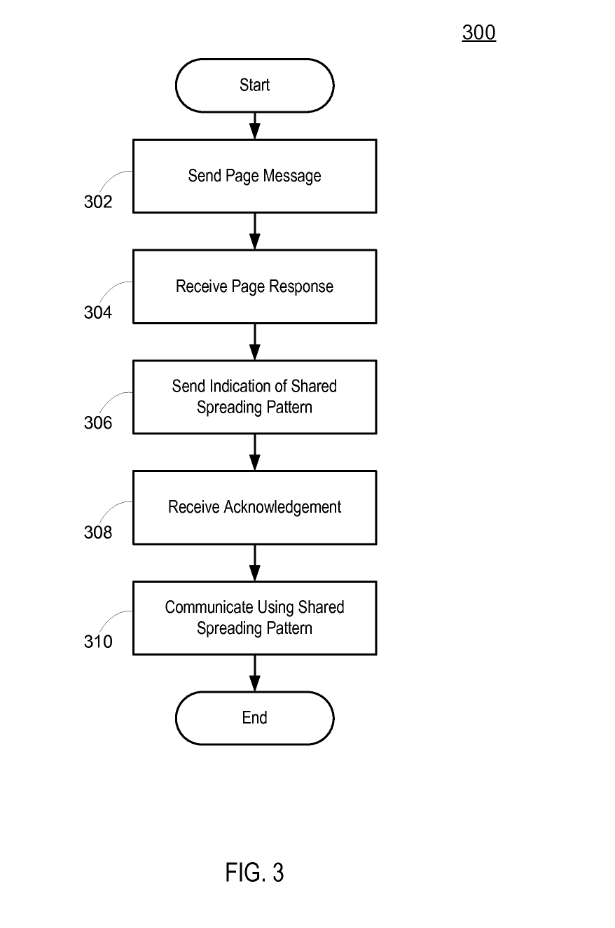

FIG. 3 is a flow diagram of a method 300 for the controller communication device 212 to communicatively couple to an IED communication device 222b. In an embodiment, the controller communication device 212 may already know and/or have received addresses and/or identifying information for the IED communication device 222b. Accordingly, the controller communication device 212 may send 302 one or more page messages to the IED communication device 222b requesting to communicatively couple to it. The one or more page messages may be sent without a spreading pattern, with a predetermined spreading pattern, and/or using multiple spreading patterns. For example, under the Bluetooth® protocol, the controller communication device 210 may send a plurality of page messages on a plurality of frequencies until the page message is received.

The controller communication device 212 may receive 304 a page response from the IED communication device 222b acknowledging receipt of the page message. The response may also indicate that the IED communication device 222b is willing to communicatively couple with the controller communication device 212. Once the page response has been received 304, the controller communication device 212 may send 306 an indication of a shared spreading pattern to the IED communication device 222b. The indication of the shared spreading pattern may be the spreading pattern itself and/or information from which the spreading pattern can be derived by the IED communication device 222b.

The controller communication device 212 may receive 308 an acknowledgement from the IED communication device 222b that the shared spreading pattern was correctly received. The controller and IED communication devices 212, 222b may communicate 310 using the shared spreading pattern once the acknowledgement has been received 308. In some embodiments, the controller communication device 212 may also or instead initiate communication to confirm that the IED communication device 222b has received the correct spreading pattern. A response from the IED communication device 222b using the spreading pattern may indicate to the controller communication device 212 that the spreading pattern was received correctly. The monitored system data may be communicated using the shared spreading pattern after the controller and IED communication devices 212, 222b have become communicatively coupled.

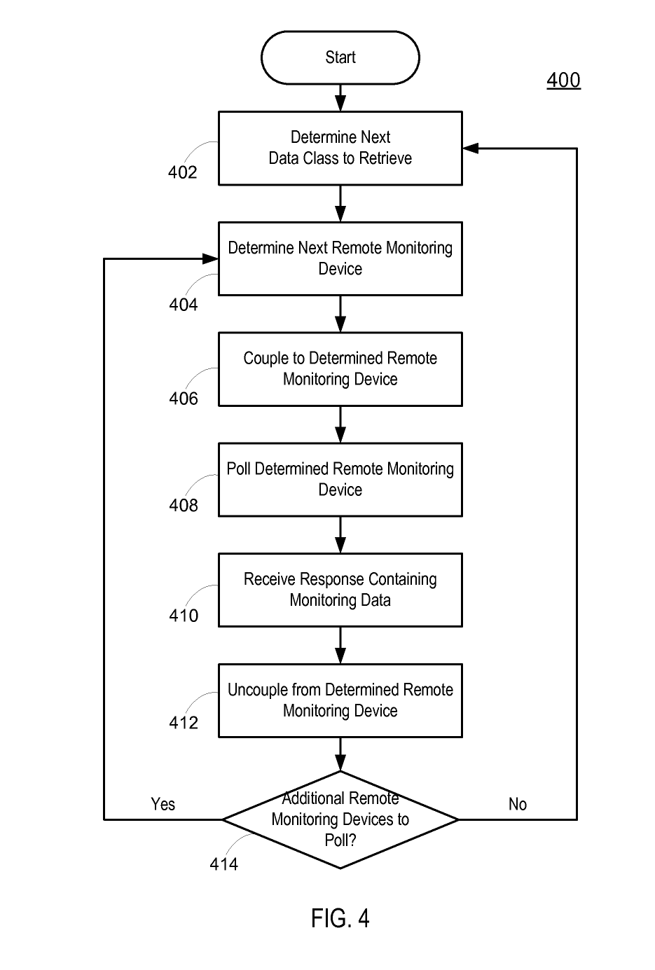

FIG. 4 is a flow diagram of a method 400 for the automation controller 210 to gather monitored system data from a plurality of IEDs 220a-d. In some embodiments, there may be a large number of IEDs 220a-d, but the spread-spectrum protocol may limit the number of devices communicatively coupled at one time. The Bluetooth® protocol, for example, may only allow for seven slaves and one master to be active on a piconet at one time, whereas a substation may have far more than seven IEDs. Accordingly, the automation controller 210 may communicatively couple and uncouple from the plurality of IEDs 220a-220d to gather monitored system data from every IED 220a-d of interest. The automation controller 210 may communicatively couple to at most one IED 220a-220d, the maximum number of IEDs 220a-d permitted by the spread-spectrum protocol, and/or some number in between.

In an embodiment, the method 400 may begin with the automation controller 210 determining 402 that one or more data classes of the monitored system data should be retrieved from the IEDs 220a-d. For example, the automation controller 210 may determine that the one or more data classes have not been collected in a predetermined amount of time and/or that the one or more data classes are next in a predetermined list and/or order of collection. The automation controller 210 may determine 404 a next IED 220a-d from which the one or more data classes should be gathered. The automation controller 210 may determine 404 the next IED 220a-d by iterating through the IEDs 220a-d in a predetermined order, by determining which IEDs 220a-d have not reported the one or more data classes within a predetermined time limit, and/or the like.

The automation controller 210 may then communicatively couple 406 the controller communication device 212 to the IED communication device 222a-d of the determined IED 220a-d, for example, using the coupling method 300. In an embodiment, communicatively coupling 406 may include causing the controller communication device 212 and/or the IED communication device 222a-d of the determined IED 220a-d to join a common piconet. The automation controller 210 may indicate to the controller communication device 212 to which IED communication device 222a-d it should connect and/or disconnect. The automation controller 210 may send an explicit command indicating the IED communication device 222a-d, may implicitly indicate the IED communication device 222a-d, for example, by including the address in a DNP3 poll sent to the controller communication device 212, and/or the like.

The automation controller 210 may poll 408 the determined IED 220a-d for the one or more data classes, such as by sending a DNP3 poll using the communicative coupling. The automation controller 210 may receive 410 a response from the determined IED 220a-d with monitored system data for the one or more data classes. In an embodiment, the response may be a DNP3 poll response. The automation controller 210 may analyze the contents of the response to determine when the IED 220a-d has completed its response.

After a complete response, the automation controller 210 may uncouple 412 the controller communication device 212 from the IED communication device 222a-d of the determined IED 220a-d. Various methods are possible for uncoupling from the IED 220a-d. In an embodiment, uncoupling may include ending communications between the controller and IED communication devices 212, 222a-d. For example, the controller and/or IED communication device 212, 222a-d may transmit an indication that it is ending communications, and/or the controller and/or IED communication device 212, 222a-d may delete the shared spreading pattern. Alternatively, or in addition, the controller communication device 212 may instruct the IED communication device 222a-d to enter a standby state, which may include minimal communication between the controller and IED communication devices 212, 222a-d. The coupling 406 and uncoupling 412 steps may mirror each other. For example, if, in an embodiment, uncoupling 412 includes the IED communication device 222a-d entering a standby state, coupling 406 may include the controller communication device 212 instructing the IED communication device to exit the standby state. Accordingly, coupling 406 may include different steps depending on whether it is occurring for a first time or occurring after a previous uncoupling 412.

The automation controller 210 may determine 414 whether the one or more data classes should be collected from additional IEDs 220a-d. If additional IEDs 220a-d need to be polled, the automation controller 210 may proceed to step 404 and determine 404 the next IED 220a-d. Otherwise, the automation controller may proceed to step 402. The automation controller 210 may determine 402 the next one or more data classes to be retrieved, and/or the automation controller 210 may remain in an idle state until it decides that additional monitored system data should be gathered.

The method 400 may be performed sequentially, but does not need to be. For example, the automation controller 210 may be coupled to more than one IED 220a-d at a time. The automation controller 210 may determine 404 and/or couple 406 to the next IED(s) 220a-d from which it will gather monitored system data and/or uncouple 412 from the previous IED(s) 220a-d from which it has already gathered monitored system data while the automation controller 210 is polling a current IED 220a-d. Time division multiplexing may be used to communicate with a plurality of the IEDs 220a-d before communication with the previous IED(s) 220a-d has completed. The automation controller 210 may also, or instead, determine 402 the one or more data classes and/or determine 404 the next IED(s) 220a-d while the controller communication device 212 is communicating with the IED communication devices 222a-d of the current IED(s) 220a-d.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure. The scope of the present disclosure should, therefore, be determined only by the following claims.

1. A system for monitoring an electric power distribution system at a plurality of points, the system comprising:
a plurality of remote monitoring devices, each configured to monitor a property of the electric power distribution system, and each comprising a monitoring device transceiver configured to communicate using a spread-spectrum radio protocol;
an automation controller comprising a controller transceiver configured to communicate using the spread-spectrum radio protocol, the automation controller configured to gather monitored system data from the plurality of remote monitoring devices in a predetermined order by:
determining a next remote monitoring device in the predetermined order,
communicatively coupling the controller transceiver to the monitoring device transceiver of the determined remote monitoring device, wherein coupling comprises creating a shared spreading pattern,
sending a poll for the monitored system data to the determined remote monitoring device,
receiving a response comprising the monitored system data from the determined remote monitoring device, and
uncoupling the controller transceiver from the monitoring device transceiver of the determined remote monitoring device.

2. The monitoring system of claim 1, wherein uncoupling comprises ending a radio connection between the controller transceiver and the monitoring device transceiver.

3. The monitoring system of claim 1, wherein uncoupling comprises instructing the monitoring device transceiver to enter a standby state with minimal communication between the controller transceiver and the monitoring device transceiver.

4. The monitoring system of claim 1, wherein the spread-spectrum radio protocol comprises a Bluetooth® protocol.

5. The monitoring system of claim 1, wherein sending a poll comprises sending a Distributed Network Protocol (DNP3) poll, and wherein receiving a response comprises receiving a DNP3 poll response.

6. The monitoring system of claim 5, wherein the automation controller is configured as a multi-drop client, and wherein the plurality of remote monitoring devices are each configured as DNP3 slaves.

7. The monitoring system of claim 1, wherein the monitored system data comprises a synchrophasor.

8. The monitoring system of claim 1, wherein the automation controller comprises a communications port communicatively coupled with the controller transceiver.

9. The monitoring system of claim 1, wherein the automation controller is configured to gather a first set of data during a first data gathering iteration and a second set of data during a second data gathering iteration, and wherein the first set of data includes at least one class of data not included in the second set of data.

10. The monitoring system of claim 1, wherein the plurality of remote monitoring devices comprise an Intelligent Electronic Device.

11. An automation control device for monitoring an electric power distribution system at a plurality of points, the device comprising:
a processor;
a communications port communicatively coupleable to a controller transceiver, the controller transceiver configured to communicate using a spread-spectrum radio protocol; and
a memory comprising a data gathering module for gathering monitored system data from a plurality of remote monitoring devices in a predetermined order, the data gathering module configured to:
determine a next remote monitoring device in the predetermined order,
communicatively couple the controller transceiver with a monitoring device transceiver of the determined remote monitoring device, wherein coupling comprises creating a shared spreading pattern,
send a poll for the monitored system data to the determined remote monitoring device,
receive a response comprising the monitored system data from the determined remote monitoring device, and
uncouple the controller transceiver from the monitoring device transceiver of the determined remote monitoring device.

12. The automation control device of claim 11, wherein the data gathering module is configured to uncouple the controller transceiver by ending a radio connection between the controller transceiver and the monitoring device transceiver.

13. The automation control device of claim 11, wherein the data gathering module is configured to uncouple the controller transceiver by instructing the monitoring device transceiver to enter a standby state with minimal communication between the controller transceiver and the monitoring device transceiver.

14. The automation control device of claim 11, wherein the spread-spectrum radio protocol comprises a Bluetooth® protocol.

15. The automation control device of claim 11, wherein sending a poll comprises sending a Distributed Network Protocol (DNP3) poll, and wherein receiving a response comprises receiving a DNP3 poll response.

16. The automation control device of claim 15, wherein the automation controller is configured as a multi-drop client, and wherein the automation controller is configured to receive responses from DNP3 slaves.

17. The automation control device of claim 11, wherein the monitored system data comprises a synchrophasor.

18. The automation control device of claim 11, wherein the data gathering module is configured to gather a first set of data during a first data gathering iteration and a second set of data during a second data gathering iteration, and wherein the first set of data includes at least one class of data not included in the second set of data.

19. The automation control device of claim 11, wherein the plurality of remote monitoring devices comprise an Intelligent Electronic Device.

20. A non-transitory computer readable storage medium comprising program code for performing a method of accessing remote monitoring devices, the method comprising:
determining a remote monitoring device to access;
instructing a local transceiver to communicatively couple to a monitoring device transceiver of the determined remote monitoring device using a spread-spectrum radio protocol, wherein coupling comprises creating a shared spreading pattern;
communicating with the remote monitoring device using a high-bandwidth protocol, wherein the high-bandwidth protocol is encapsulated in the spread-spectrum radio protocol; and
instructing the local transceiver to uncouple from the monitoring device transceiver of the determined remote monitoring device.

21. The non-transitory computer readable storage medium of claim 20, wherein the method further comprises communicatively coupling to a user, and wherein communicating with the remote monitoring device comprises transmitting commands from the user to the remote monitoring device using the high-bandwidth protocol.

22. The non-transitory computer readable storage medium of claim 20, wherein communicating with the remote monitoring device comprises collecting relay event data from the remote monitoring device.
